(19) United States
(12) Patent Application Publication
(10) Pub. No.: US 2014/0208658 A1
(43) Pub. Date: Jul. 31, 2014

(54) ACCESS FIXTURE

(71) Applicant: Richard Jelacic, Castle Hill (AU)

(72) Inventor: Richard Jelacic, Castle Hill (AU)

(21) Appl. No.: 14/342,994

(22) PCT Filed: Sep. 4, 2012
(86) PCT No.: PCT/AU2012/001039

§ 371 Date: Mar. 5, 2014

(30) Foreign Application Priority Data
Sep. 6, 2011 (AU) 2011903617

(51) Int. Cl. E04D 13/076; E06B 7/28

(52) U.S. Cl. CPC E04D 13/076; E06B 7/28
USPC 49/465; 29/557

(57) ABSTRACT

An access fixture is providing, having a base frame (100) having an inner edge (14) and an outer edge (12) and generally defining an opening of the access fixture, and at least a pair of tabs (2) provided adjacent inner edges (14) of the frame (100). The tabs (20) are preferably integral with the base frame (100) and are adapted to operatively secure the access fixture to an appropriately dimensioned aperture in a gutter guard, downpipe, ducting or the like.

### FIELD OF THE INVENTION

The present invention relates to an access fixture suitable for use with gutter guards, downpipes, ducts and the like.

### BACKGROUND OF THE INVENTION

Traditionally, rainwater gutters used in conjunction with pitched roofs in Australia and elsewhere have been provided as an open channel feeding downpipes that feed the collected water to stormwater drainage or a rainwater storage tank.

Over recent years, however, aftermarket or retrofitted gutter guards have been developed and installed for the purpose of discouraging the accumulation of leaf and other litter in rainwater gutters. These gutter guards rely upon a mesh or screen to readily accept ingress of water to the rainwater gutter, while largely deflecting leaf and other litter. A variety of products are available, and have achieved a level of acceptance in the market. One example of a mesh gutter guard is described in Australian Innovation Patent No. 2005100465, published 7 Jul. 2005 and entitled ‘Ultraguard gutter protection mesh’, the contents of which is hereby incorporated by reference.

Typically, mesh gutter guards of the type referred to above are fastened to some part of the roofing structure such that removing the guard is a difficult or awkward operation, and is prone to damage the gutter guard or the roofing installation. While such mesh gutter guards offer protection against leaf and similar large debris, they do not stop ingress of finer particles that can pass through the mesh and accumulate within the gutter, potentially encouraging corrosive degradation of the guttering. While rainwater may assist in flushing away these finer accumulated particles, regular gutter maintenance by cleaning is still desirable. Existing gutter guard arrangements are not designed to be readily detached from the roofing structure for this purpose.

There is, in view of the foregoing, a need for improvements to existing gutter guards that at least to attempt to overcome the abovementioned and other limitations, or at least provide a useful alternative.

### SUMMARY OF THE INVENTION

The present invention provides, in one aspect, an access fixture comprising:
a base frame having inner and outer edges and generally defining an opening of the access fixture; and
at least a pair of tabs provided adjacent the inner edge of the frame;
wherein the tabs are adapted to operatively secure the access fixture to an appropriately dimensioned aperture in a gutter guard, downpipe, ducting or the like.

The access fixture is preferably of integral, planar construction fabricated from a metal plate, and having a generally rectangularly-shaped frame having inner and outer edges and generally defining an opening of the access fixture. The tabs are preferably formed integrally with the frame and extending inwardly from an inner edge of the frame on each of the sides of the inner edge of the frame. The tabs are adapted to be operatively secure the access fixture to an appropriately dimensioned aperture in a gutter guard, downpipe, ducting or the like by bending the tabs back against the frame towards its outer edge to thereby secure the access fixture against the fabric of the gutter guard adjacent its aperture.

The present invention also extends, in another aspect, to a method of fabricating an access fixture of integral, planar construction fabricated from a metal plate, method comprising steps of:
cutting a base frame in a laminar metal plate by cutting an outer edge of the base frame of a generally rectangular shape, and by cutting an inner edge of the base frame, leaving tabs extending inwardly from the inner edge from at least two opposed sides of the inner edge; and
stamping the base frame to form guide slots running along opposing sides of the base frame for receiving in slotting engagement a cover plate for removably covering an opening defined by the base frame.

The present invention yet further provides, in another aspect, a method of installing an access fixture in a gutter guard, downpipe, ducting or the like, the method comprising steps of:
cutting a suitably dimensioned aperture in a guard, downpipe, ducting or the like;
placing over the aperture an access fixture comprising a base frame having inner and outer edges and generally defining an opening, and at least a pair of tabs provided adjacent the inner edge of the frame;
securing the access fixture in place by bending back the tabs into the aperture; and
optionally covering the opening with a cover plate removably held or supported in place by guide slots formed along opposing edges of the base frame.

### BRIEF DESCRIPTION OF DRAWINGS

FIG. 1 is a perspective view of a base frame, and FIGS. 2 to 4 are respectively a top plan, and transverse and longitudinal elevations of the base frame of FIG. 1.

FIG. 5 is a perspective view of a cover plate for use in conjunction with the base frame of FIG. 1, and FIGS. 6 to 8 are respectively a top plan, and transverse and longitudinal elevations of the cover plate of FIG. 5.

FIGS. 9A to 9D are graphical representations of steps involved in fitting the access fixture comprising the base frame and cover plate depicted in FIGS. 1 to 8 to a mesh gutter guard.

FIGS. 10A to 10D are corresponding graphical representations of steps involved in fitting the access fixture comprising the base frame and cover plate depicted in FIGS. 1 to 8 to a downpipe.

FIG. 11 is a graphical representation of an intended use of the access fixture comprising the base frame and cover plate depicted in FIGS. 1 to 8 when installed on a mesh gutter guard.

### DETAILED DESCRIPTION OF PREFERRED EMBODIMENTS

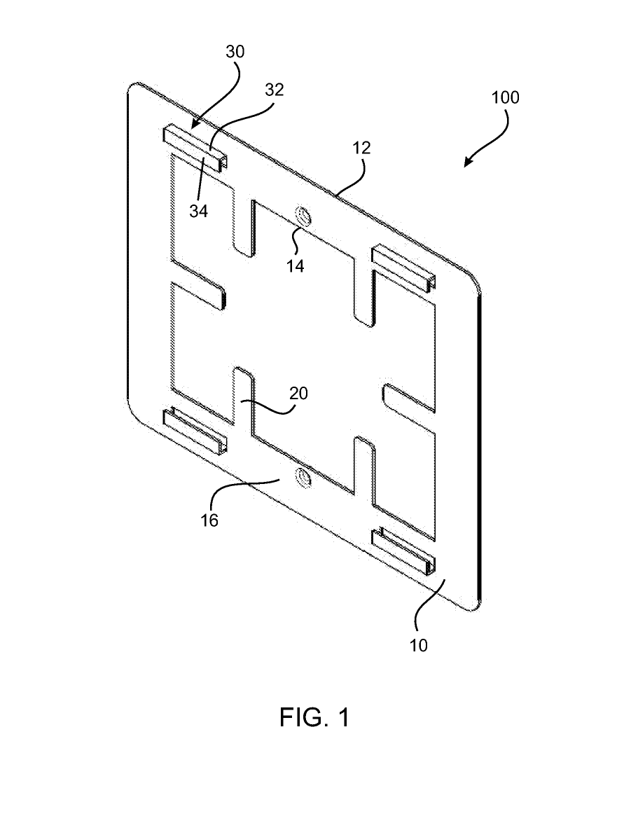

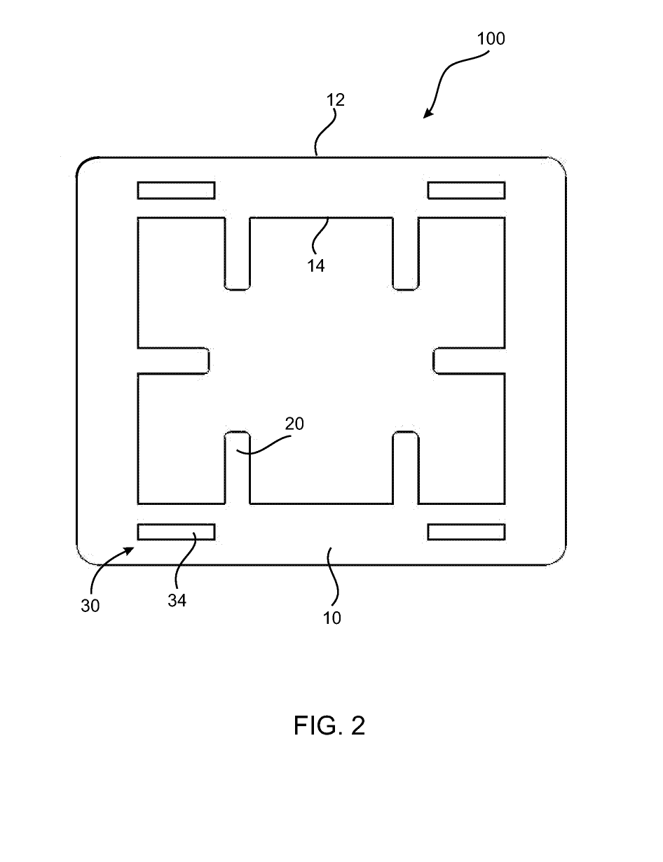

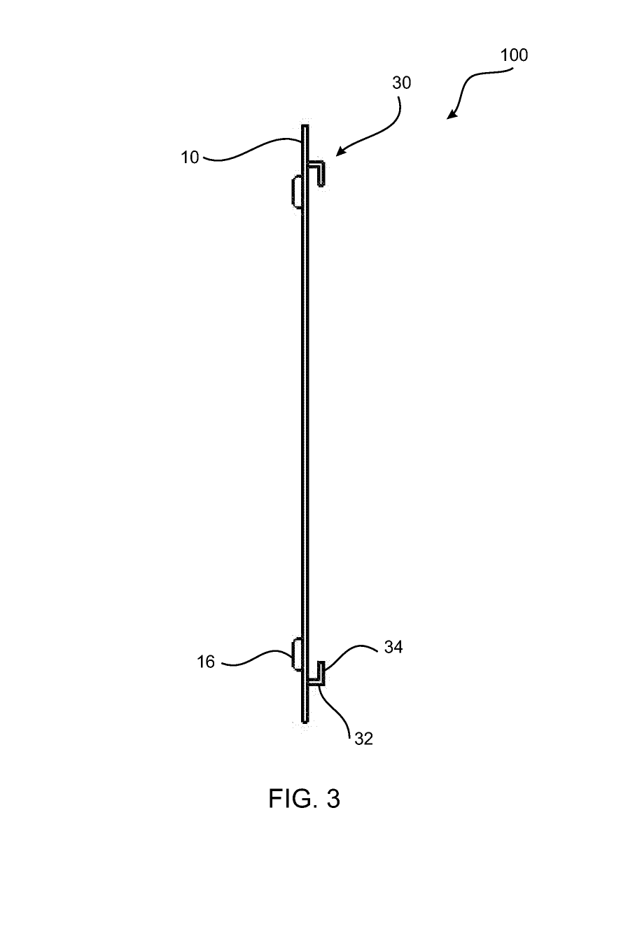

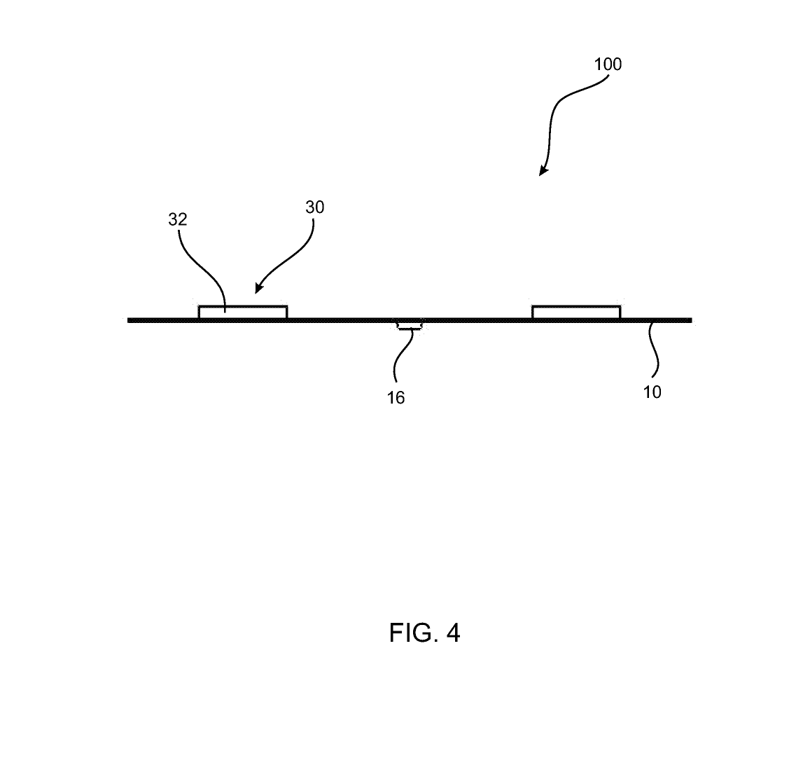

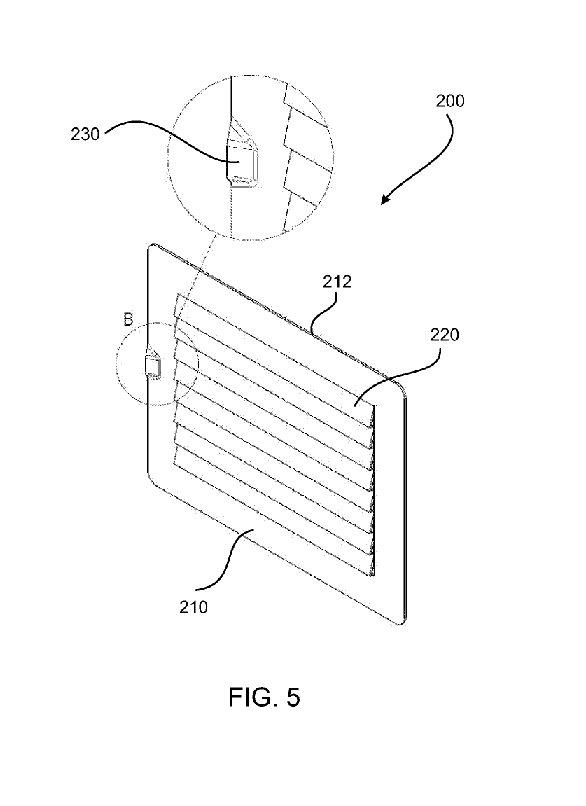

FIGS. 1 to 4 collectively depict a base frame 100 of an access fixture that optionally also has a cover plate 200 collectively depicted in FIGS. 5 to 8.

The base frame 100, formed from a flat plate, comprises a surround 10, having an outer edge 12 and an inner edge 14, and a series of tabs 20 integral with the surround 10 and extending generally inwardly of the surround 10 from the inner edge 14. The surround 10, or more particularly its inner edge 14, defines an opening of the access fixture. The base frame 100 is generally rectangular, and while it may of course be square, preferably has major and minor dimensions that define corresponding longitudinal and transverse axes as depicted.

The base frame 100 is generally rectangularly, despite rounded corners formed on the outer edge 14. The rounded corners on the outer edge 14 improve the aesthetic appearance of the base frame 100, as well as avoid an exposed sharp edge.

The tabs 20 formed integrally with the surround 10 are spaced apart in a series such that there are two tabs formed along both of the opposed longitudinal sides of the frame 10, and a single tab formed along both of the opposed transverse sides of the frame 10, as depicted.

The surround 10, along its longitudinal sides, has formed therein guide means in the form of two guide lugs 30 spaced apart from each other along both of the opposed longitudinal sides of the surround 10. The guide lugs 30 collectively define a slot for insertion of a cover plate 200 for the base frame 100, as described below in further detail with reference to FIGS. 5 to 8. The guide lugs 30 are formed integrally with the surround 10.

The guide lugs 30 all face inwardly towards the opening of the base frame 100 and have projecting flange 32 and a retaining flange 34. The projecting flanges 32 extend directly from the surround 10 and act to space the retaining flanges 34 from the surround 10, and also to define the extent of the slot defined by the guide lugs 30. The retaining flanges 34 and guide flanges 32 co-operatively and collectively act to guide, support and retain the cover plate 200 in use.

FIGS. 5 to 8 collectively depict a cover plate 200 intended to be used in conjunction with the base frame collectively depicted in FIGS. 1 to 4. The cover plate 200 is formed from a flat plate, preferably of the same material, thickness and finish as that used to form the base frame 100. The cover plate 200 has an outer edge 212 that is generally rectangular, notwithstanding rounded corners formed in its outer edge 212, as with the outer edge 12 of the surround 10 of the base frame 100. The outer edge 212 similarly bounds a periphery 210 of the cover plate 200.

The planar dimensions and aspect ratio of the cover plate 200 are commensurate with those of the base frame 100. Moreover, the planar dimensions of the cover plate 200 are such that the cover plate 200 can be snugly slotted into the slot defined by the guide lugs 30. When so slotted, the cover plate 200 at least partly, though preferably entirely, covers the opening of the base frame 100. The cover plate 200 can readily be slotted into the base frame 100, and retained there despite no means acting specifically against longitudinal movement of the cover plate 200 relative to the base frame 100.

The guide lugs 30 are formed along both of the opposed longitudinal sides of the frame 10 in a spaced apart fashion, generally proximate to opposite ends of these longitudinal sides, as apparent most clearly from FIG. 1. This positioning of the guide lugs 30 has the advantage that the slot defined by the guide lugs runs generally along an extent of the longitudinal sides of the frame 10, which assists in appropriately and securing positioning the cover plate 200 over the opening defined by the base frame 100.

The cover plate 200 has formed along one side of the outer edge 212 a projection 230, which may assist in sliding the cover plate 200 in use by allowing a finger to press against the projection 230.

The cover plate 200 has formed therein at an arbitrary distance from its outer edge 212 a series of louvres 220 that run along the longitudinal extent of the cover plate 200 is a generally parallel and adjacent arrangement, as most clearly apparent from FIG. 5. The louvres comprise a surface projecting at a relatively shallow inclined angle from the cover plate 200, along one longitudinal edge integral with the cover plate 200 and at an opposite longitudinal edge cut away and spaced apart a short distance from the cover plate 200, as depicted. Transverse edges of each louvre 200, which connect these longitudinal edges, are integral with both the cover plate 200 and the surface of the louvre 220 inclined therefrom.

The louvres 220 preferably cover a substantial extent of the planar area of the cover plate 200, arbitrarily spaced from the outer edge 212 of the cover plate 200 as described above. The louvres collectively lend the cover plate 200 a pleasing appearance, while also maintaining the integrity of the cover plate 200 (to ingress from foreign objects, for example) and permitting ventilation through the cover plate 200.

The access fixture, comprising the base frame 100 and preferably also the cover plate 200, is operatively installed in a gutter guard of downpipe or other ducting having a substantially planar surface.

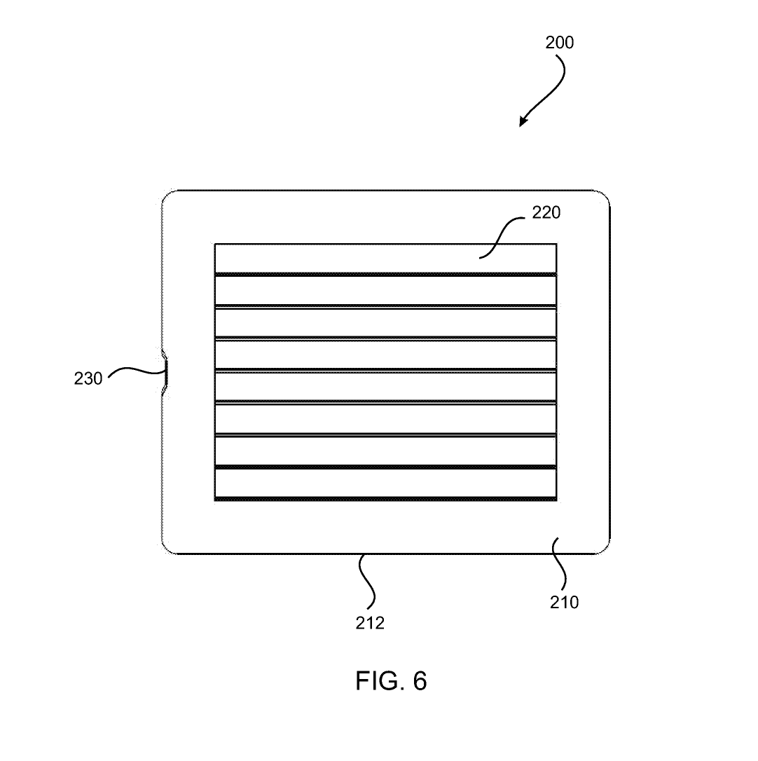

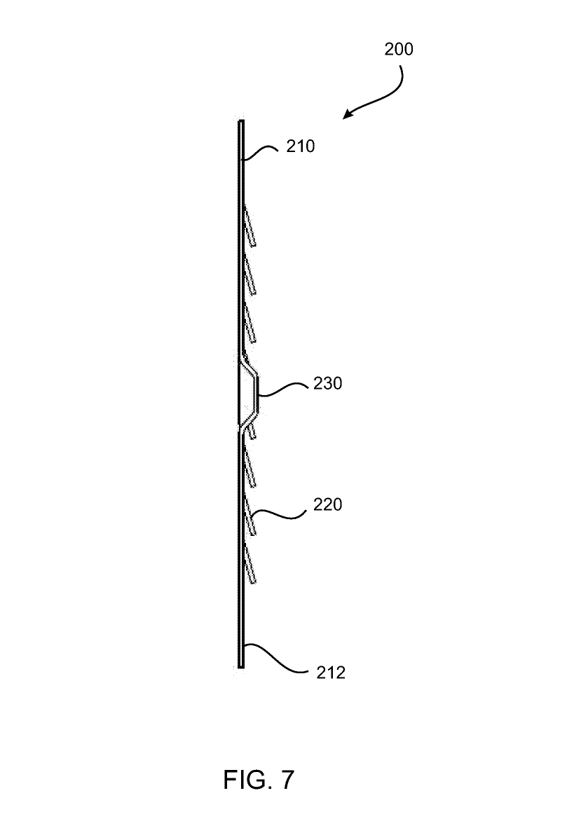

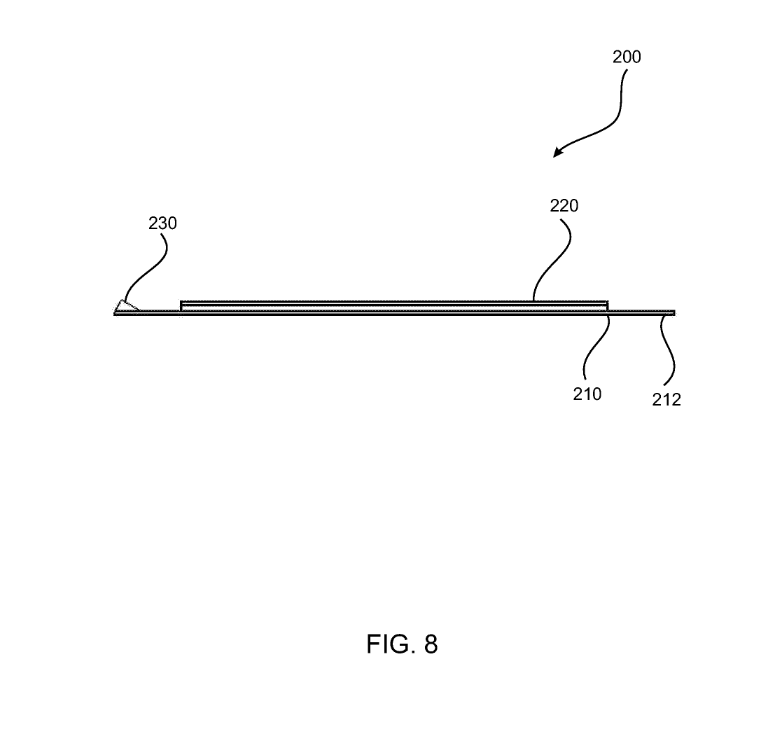

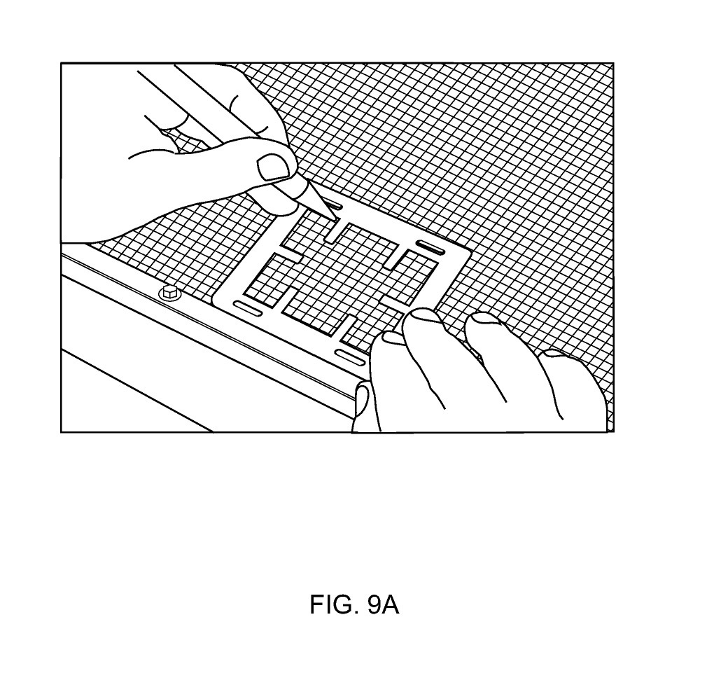

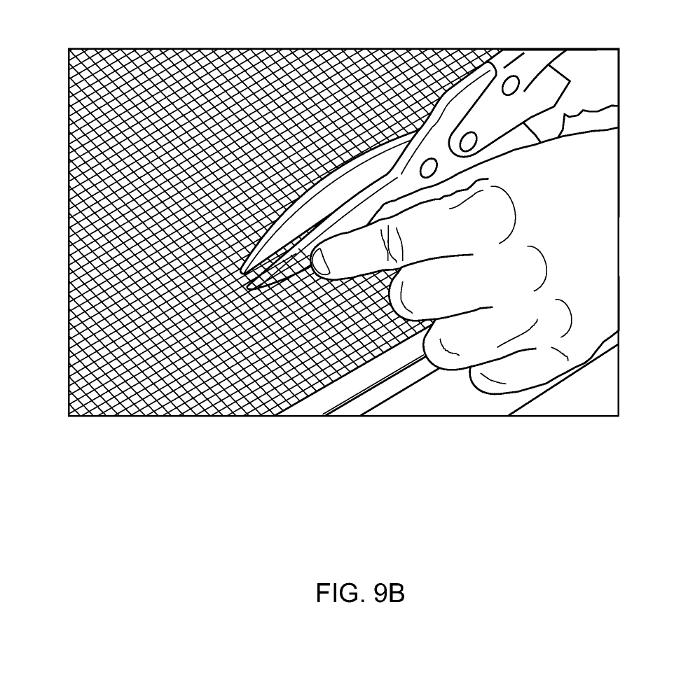

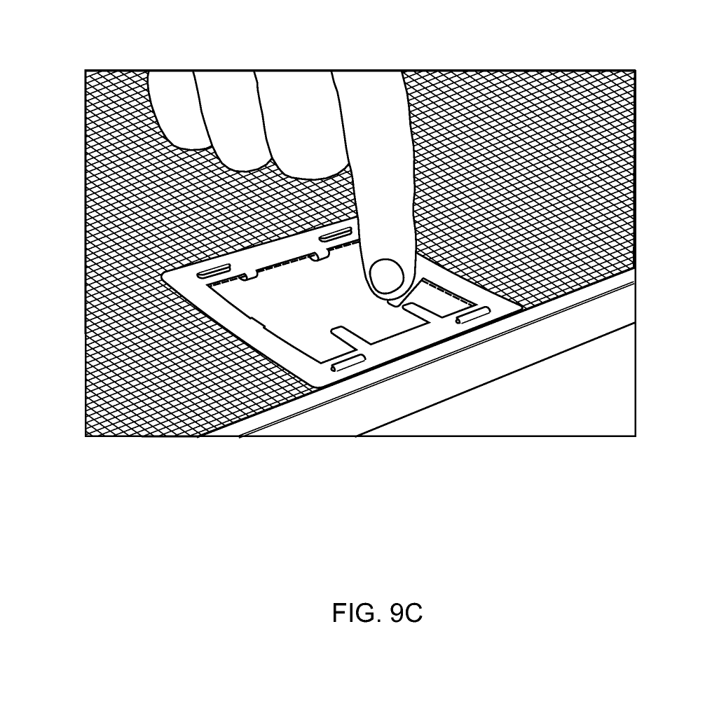

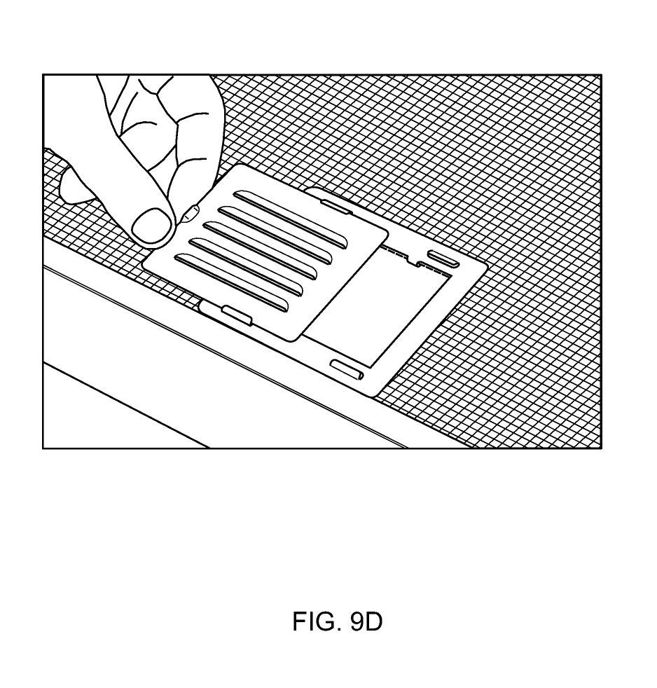

FIGS. 9A through to 9D illustrate by graphical representations, a series of steps involved in installing the access fixture on a mesh gutter guard generally of the type referenced above. First, the base frame 100 is placed and held in the position in which it is intended to be installed, and a marker used to trace on the mesh of the gutter guard a template conforming with the inner edge 14 of the frame 10, as depicted in FIG. 9A. Second, a pair of clippers, scissors or similar cutting implement is used to cut in the mesh of the gutter guard an aperture corresponding to that marked by the template drawn earlier, and thus conforming with the opening of the access fixture, as depicted in FIG. 9B. Third, the base frame 100 is placed over the aperture so cut in the mesh gutter guard, and the tabs 20 are bent backwards past the mesh and into an internal region of the gutter and secured back against the opposite surface of the mesh, as depicted in FIG. 9C. Once all the tabs 20 are bent back in like fashion, the base frame 100 will be secured in place in the gutter guard, so that the opening of the access fixture permits access to the gutter. Fourth, the louvred cover plate 200 can be slotted over the opening of the access fixture, as depicted in FIG. 9D. The louvres are preferably directed ‘pointing down’ the inclined angle of the mesh gutter guard, so that leaf and like litter is more readily rejected by the cover plate 200.

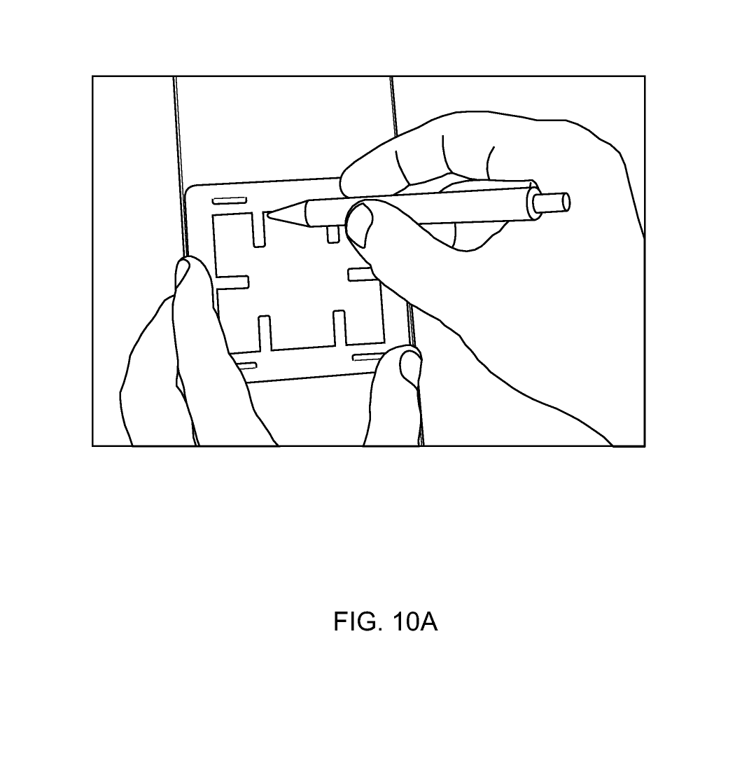

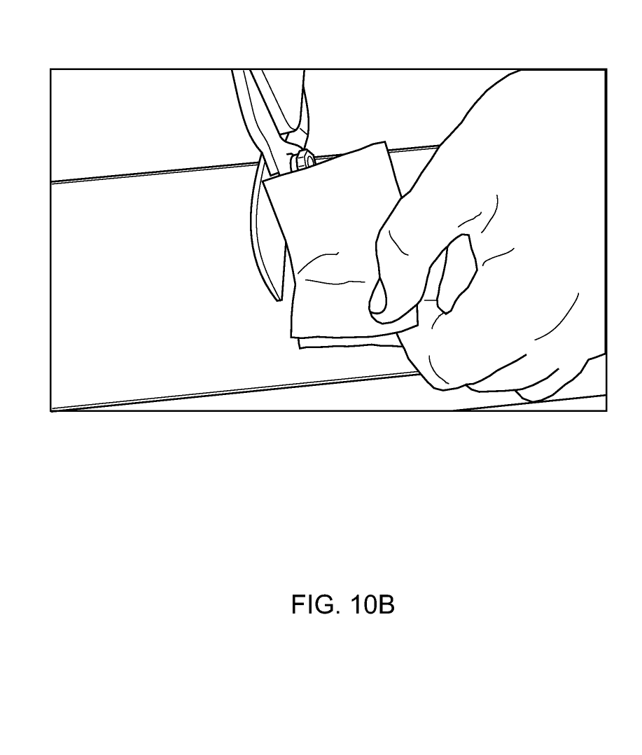

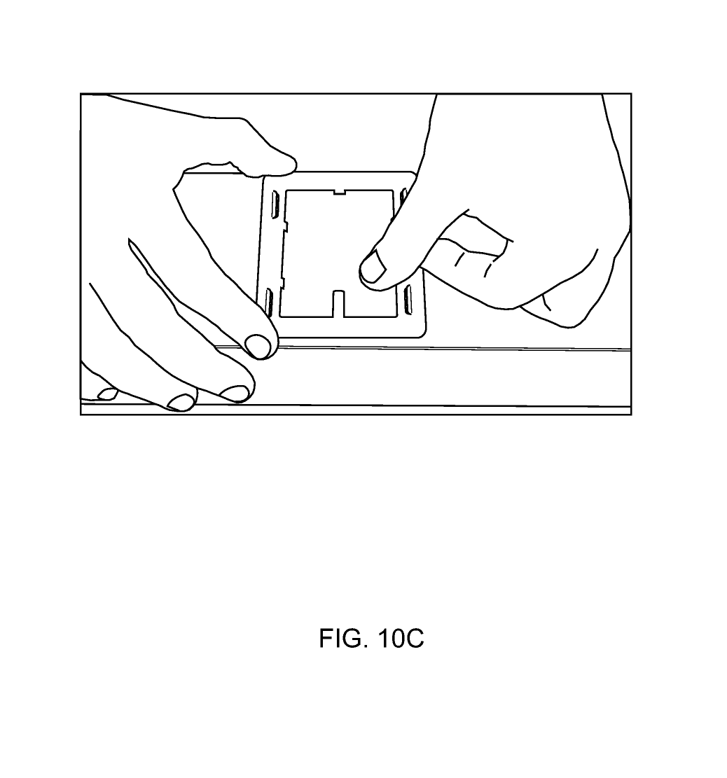

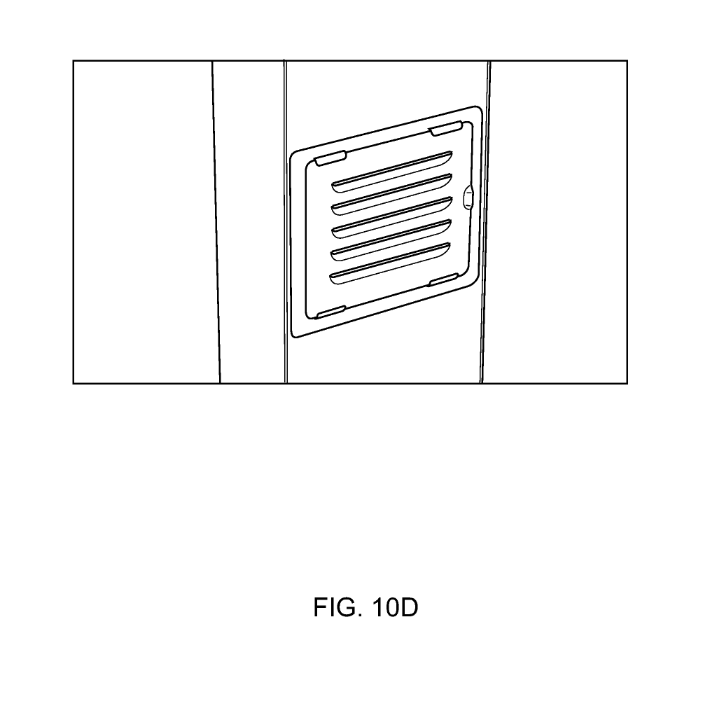

FIGS. 10A to 10D illustrate by graphical representations, a series of steps involved in installing the access fixture on ducting or a downpipe having a generally planar surface. The analogous steps apply, as indicated by the analogous representations of FIGS. 10A to 10D. Where installed on a vertically oriented downpipe, the louvres of the cover plate 200 are preferably installed ‘pointing up’, as depicted in FIG. 10D. This assists with minimising splashing and spillage from the downpipe when channelling rainwater.

Though the access fixture is depicted as installed in an orientation aligned with the guttering or downpipe, any arbitrary orientation can be adopted, though if a cover plate 200 is used, it is prudent to avoid any orientation in which the cover plate 200 may slide out from the base frame 100 under influence of gravity.

Installation of the access fixture can be supplemented if required with a sealant, such as a silicone sealant along the outer edge 12 of the base frame 100 is a better seal is required.

Though two examples of installation of the described access fixture are provided with reference to FIGS. 9 and 10, the access fixture can in practice be installed in a wide variety of other sites where access for cleaning or inspection is required.

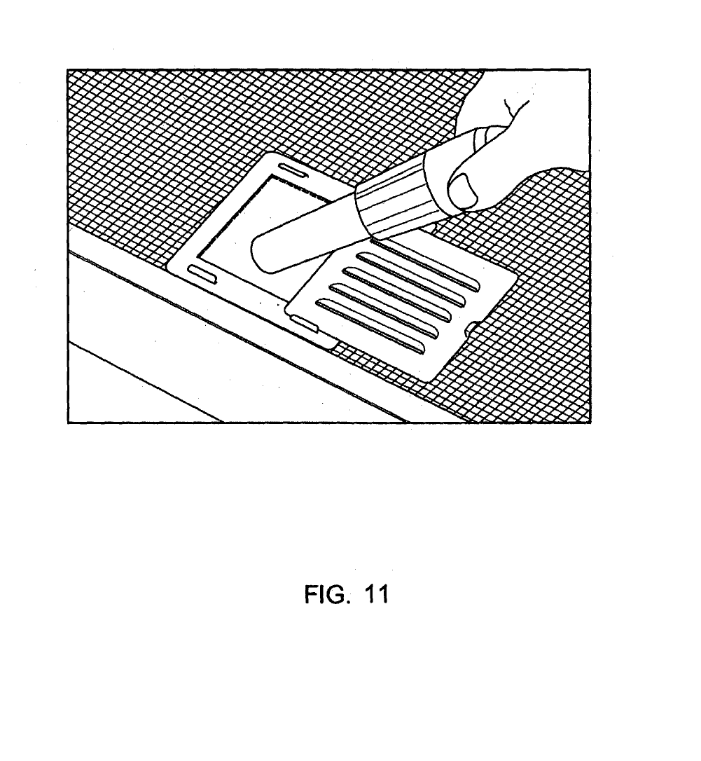

FIG. 11 depicts an access fixture, installed in a mesh gutter guard, with the cover plate 200 of the access fixture partly removed to allow access to the opening of the access fixture and thus inspect of the gutter upon which the mesh gutter guard is installed. This allows, as depicted, a garden hose nozzle to be placed partly within the gutter to provide a stream of water to the gutter to flush loose dirt, debris, et cetera, from the gutter. After access, the cover plate 200 can be restored to its usual position fully covering the opening of the access fixture.

The access fixture described herein, both the base frame 100 and cover plate 200 are desirably fabricated using a suitable press machine loaded with dies shaped to form these pieces 100, 200 by cutting and stamping operations working on integral, planar plates. The plate from which these pieces 100, 200 are formed are preferably a corrosion-resistant form of steel, such as galvanized iron plate. Preferably, steel plate supplied under the Colorbond brand by BlueScope Steel Limited is used to form the pieces 100, 200, as it is corrosion resistant and available in colours that match existing guttering and downpipe installations formed using this material.

1. An access fixture comprising:
a base frame having inner and outer edges and generally defining an opening of the access fixture; and
at least a pair of tabs provided adjacent the inner edge of the frame;
wherein the tabs are adapted to operatively secure the access fixture to an appropriately dimensioned aperture in a gutter guard, downpipe, ducting or the like.

2. The access fixture of claim 1, wherein the tabs are formed integrally with the base frame.

3. The access fixture of claim 2, wherein the base frame and the tabs are of integral planar construction formed from a metal plate.

4. The access fixture of claim 1, further comprising guide means formed on the base frame for guiding into position a cover plate for removably covering the opening defined by the base frame of the access fixture.

5. The access fixture of claim 4, wherein the guide means comprise guide lugs running along at least part of opposing edges of the base frame to thereby define a slot into which the cover plate can be placed to removably cover the opening.

6. The access fixture of claim 5, further comprising a cover plate for removably covering the opening defined by the base frame of the access fixture by slotting engagement with the guide lugs.

7. The access fixture of claim 6, wherein the cover plate has formed therein a series of louvres.

8. An access fixture of integral, planar construction fabricated from a metal plate, the access fixture comprising:
a generally rectangularly-shaped frame having inner and outer edges and generally defining an opening of the access fixture; and
tabs formed integrally with the frame and extending inwardly from an inner edge of the frame on each of the sides of the inner edge of the frame;
wherein the tabs are adapted to operatively secure the access fixture to an appropriately dimensioned aperture in a gutter guard, downpipe, ducting or the like by bending the tabs back against the frame towards its outer edge to thereby secure the access fixture against the fabric of the gutter guard adjacent its aperture.

9. The access fixture of claim 6, further comprising at least one pair of guide slots formed along opposed edges of the base frame by stamping the base frame.

10. A method of fabricating an access fixture of integral, planar construction fabricated from a metal plate, the method comprising steps of:
cutting a base frame in a planar metal plate by cutting an outer edge of the base frame of a generally rectangular shape, and by cutting an inner edge of the base frame to define an opening in the base frame, while leaving tabs extending inwardly from the inner edge from at least two opposed sides of the inner edge; and
stamping the base frame to form guide slots running along opposing sides of the base frame for receiving in slotting engagement a cover plate for covering the opening defined by the base frame.

11. A method of installing an access fixture in a gutter guard, downpipe, ducting or the like, the method comprising steps of:
cutting a suitably dimensioned aperture in a guard, downpipe, ducting or the like;
placing over the aperture an access fixture comprising a base frame having inner and outer edges and generally defining an opening, and at least a pair of tabs provided adjacent the inner edge of the frame;
securing the access fixture in place by bending back the tabs into the aperture; and
optionally covering the opening with a cover plate removably held or supported in place by guide slots formed along opposing edges of the base frame.
